(19) United States
(12) Patent Application Publication
(10) Pub. No.: US 2018/0290770 A1
(43) Pub. Date: Oct. 11, 2018

(54) Rotary Propulsion Engine System

(71) Applicant: Aaron Allen Opalek, Las Vegas, NV (US)

(72) Inventor: Aaron Allen Opalek, Las Vegas, NV (US)

(21) Appl. No.: 15/947,145

(22) Filed: Apr. 6, 2018

Related U.S. Application Data
(60) Provisional application No. 62/483,226, filed on Apr. 7, 2017.

(51) Int. Cl. B64G 1/40; F03G 3/00; F41B 6/00

(52) U.S. Cl. CPC B64G 1/409; F03G 3/00; B64C 39/001; F41B 6/003; F41B 6/006

(57) ABSTRACT

A rotary propulsion engine system designed to propel a craft. Such a rotary propulsion engine system comprises at least two reaction masses or armatures, at least two reaction mass driver assemblies, at least two travel pathways for said reaction masses or armatures, two counterrotating discs housing an equal number of the at least two said reaction mass driver assemblies, and a counterbalancing means used to maintain a balanced distribution of masses about the axis of rotation of each counterrotating disc in order to maintain a zero horizontal torque sum as each reaction mass or armature moves along its ballistic trajectory. Reaction masses are fired into a rotational environment wherein the kinetic energy of said reaction masses is recycled, thereby reducing or eliminating the need for chemical propellant-based propulsion systems, and transporting heavy, finite, and expensive fuels for combustion.

### CROSS-REFERENCE TO RELATED APPLICATIONS

The present utility patent application claims priority benefit of the U.S. provisional application for patent Ser. No. 62/483,226 titled “Rotary Propulsion Engines,” filed on Apr. 7, 2017 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### BACKGROUND OF THE INVENTION

### 1. Field of the Invention

One or more embodiments of the invention generally relate to propulsion systems. More particularly, embodiments of the invention relate to an experimentally-based, momentum conserving, propulsion system which merges ballistics with rotordynamics to produce a relatively energetic and efficient rotary propulsion engine system wherein ejected reaction mass stock from the internal “core control volume” or propulsive system, is injected into an independent external surroundings rotational environment, which recycles it, without compromising craft propulsive phase acceleration gains.

### 2. Description of the Related Art

For the past century, spacecraft have been traditionally driven by chemical propellant rockets. In such rocket-type engines, thrust is produced at the nozzle which is located at the tail end of the rocket. At the nozzle, hot exhaust (reaction mass) is accelerated into the external surroundings, to propel the rocket. The exit velocity, pressure, and mass flow through the nozzle determines the amount of thrust produced by the nozzle. Thrust being a reaction force described quantitatively by Newton's Second and Third Laws of Motion. When a system expels or accelerates mass, including ions in ion thrusters, in one direction, the accelerated mass will cause a force of equal magnitude but opposite direction on that system. As gas, ions or working fluid is accelerated to the rear, the engine and rocket are accelerated in the opposite direction. Conservation of Momentum principles are strictly obeyed during this process, as the momentum of the rocket is always equal and opposite to the momentum of the exhausted gases.

Limitations in rocket propulsion systems such as fuel capacity have led to research to develop alternative propulsion systems. Presently, there exists a need for a more versatile and powerful propulsion systems for space travel which do not depend on limited or low thrust fuel supplies. One option would be the development of a propulsion system that could recycle the system's reaction mass for repeated use, while maintaining the craft's flight trajectory under appreciable thrust.

To date, there have been very few instances, if any, in scientific literature providing viable means for avoiding expulsion of reaction mass in the course of totally independent craft propulsion. Offered proposals, at times, seem to contradict physical laws such as conservation of momentum, and even then fall short on linear thrust, stability and practicality requirements.

### SUMMARY

The present invention introduces a transformational breakthrough, experimentally based, technology, which merges ballistics with rotordynamics technologies to produce energetic and highly efficient internally mediated acceleration (IMA) rotary propulsive engines that require minimal reaction mass stock. These engines operate as thermodynamically open systems, meaning that mass can cross the boundary between the “core control volume” or propulsive system and the surroundings, and that energy, in the form of, say, heat or work, may also freely be exchanged with the surroundings. Furthermore, these engines are designed for sustained accelerations, and as such are exceptionally suited for spacecraft and other aerospace applications. The primary benefit of this technology is that it is designed to replace, among others, propellant-based propulsion systems, hence eliminating the need for using and transporting heavy, finite, and expensive fuels for combustion. The only requirement of this propulsive technology would therefore be a source of energy such as nuclear or solar energy.

This technology is buttressed by reproducible proof of concept experiments, and an in-depth mathematical treatment which combines the physics of ballistics of such mass drivers as rail guns, coil guns, and rotor dynamics applied sciences. The invention operates on the general principle of linear recoil (thrust) linked to a rotating environment.

Briefly, Newton's Third Law of Motion fundamentally states that “for every action force, there is an equal, and opposite reaction force acting along the same line.” This law holds true for electromagnetic systems just as it holds true for chemical or mechanical systems. Essentially, the concept is based on the fact that recoil (thrust), i.e. propulsion, of a mass driver such as a firearm occurs only while a projectile is being driven within a gun barrel, rail, or coil, which constitute the respective propulsive control volumes, where the net rate of change of momentum is always equal to zero, and the fact that a rotating mass, when acted upon by rotational forces, due to its linear inertia, constantly strives to tangentially and outwardly escape its circular confinement. Said rotational forces acting on the mass can only affect the attitude but not the linear displacement of the craft, i.e. they are not accompanied by craft linear recoil.

To illustrate the point, in a simple to perform experiment, which will be discussed in greater detail, a mass, such as a ring, is inserted onto a rod mounted on an axis of rotation. When the rod is rotated, the mass is driven outwardly by rotational forces acting on it. These rotational forces, as is the case with reaction wheels of satellites, can only affect the attitude (rotation) of the rod and not its linear displacement. As such, the axis of rotation is not subject to opposite and equal linear forces as would be the case with a firearm, hence no linear recoil accompanies the expulsion of the mass outwardly.

In another reproducible experiment, the mass is injected, with proper force, inwardly into a spinning rod, where upon, due to the rotational forces acting on it, it is brought to a holt along the rod, and as in the previous experiment, it is likewise driven outwardly, without an accompanying recoil acting on the axis of rotation.

Perhaps it would be useful at this juncture to briefly highlight the operational difference between the open systems of, rocket propulsion and firearm propulsion (recoil), to which this engine is more akin. In a rocket engine, as noted above, thrust is produced at the nozzle, which is located at the tail end of the rocket. At the nozzle, hot exhaust (reaction mass) is accelerated into the external surroundings, to propel the rocket. The exit velocity, pressure, and mass flow through the nozzle determines the amount of thrust produced by the nozzle. Conservation of momentum laws are strictly obeyed during this process, as the momentum of the rocket is, at all times, equal and opposite to the momentum of the exhausted gases.

Contrarily to the operation of a rocket, where thrust takes place as accelerated reaction mass exits the rocket's nozzle, in accordance with internal ballistics physics, propulsion (recoil) in mass drivers such as firearms, railguns or coil guns is carried out at the breech or along the coils or rails, and ceases at the muzzle—which means, that the dissimilarity of their mechanisms of action, necessitates, a different approach to the utilization of their propulsive capabilities. However, and this is very important, both are bound by the same laws of physics. As was the case with the rocket, Newton's laws of motion and conservation of momentum laws are strictly adhered to by the internal ballistics physics of firearms, railguns or coil guns, and the like. The stark difference in their mechanism of action can be visually demonstrated, with the use of high-speed cameras, where a fired gun will seem, to an observer, to be magically thrusting itself, in the absence of an external force, during the recoil phase, as an unseen projectile is being propelled within the barrel. On the other hand, a rocket's exhaust is clearly visible during its propulsive phase, and is intuitively linked, by an observer, with its acceleration.

It should be further understood that unlike traditional ballistic devices, it is not the goal or purpose of the present invention to hurl a projectile further and with the highest possible velocity. The main purpose is to generate the greatest recoil or thrust force, during the propulsive phase. To that end, the reaction mass or armature (projectile) can be as massive as possible and travel at a speed most advantageous for craft acceleration.

Structurally, one possible version represents an engine, which is composed of at least one pair of counter-rotating discs. Bisecting the diameter of each disc is at least one pair of opposing travel pathways, each spanning from the disc's periphery to the axis of rotation. The peripheral end of one travel pathway, houses a reaction mass driving device, such as, but not limited to, a rail gun or a coil gun, which constitutes the open “core control volume”. At the opposite end of each travel pathway and on the periphery of the disc are situated a pair of counter balances, that can rotate about the circumference of the disc, as to maintain a torque equilibrium with the reaction mass.

Operation of the present invention involves two independent phases, propulsive and rotary. During the interior ballistic phase, or propulsive phase, the reaction mass is fired inwardly. The propulsive phase may be executed in a non-rotational or rotational environment. A non-rotational setting, is more efficient, as among others, thrust is focused in one direction, and as such will be adapted here.

In accordance with Newton's laws of motion, the inward firing of a reaction mass generates a recoil (thrust) force which drives the craft. The thrust generated by all variants of the rotary engines operate in accordance with Newton's 3^{rd} law of motion, which states that the propulsive force Fₚ(t), acting on a reaction mass (projectile) is accompanied by an equal and opposite reaction (recoil) force F_{c}(t) acting on the mass driving device, and hence on the craft, such that

Fₚ(t)=F_{c}(t)

The sum of all internal and external forces F_{c-sum}(t), acting on the craft, during a propulsive phase in a rail, is given as:

F_{c-sum}(t)=F_{c}(t)−F_{Rinate}−ƒ_{μsum}(t)−F_{D}

Where F_{Rinate} is the innate inertial resistive linear force of the craft to recoil motion, which is a function of its mass. ƒ_{μsum}(t) is the sum of the frictional forces, as a function of time, generated between the propelled armatures and associated conducting rails, ƒ_{μsum}(t)=μₛᵤₘF_{c}(t), and F_{D} is the fluid resistive drag force as applicable to craft recoil motion. For multiple active rails acting in unison, F_{c}(t) and μₛᵤₘF_{c}(t) would be scaled accordingly.

The actual recoil motion is only possible when the craft's resistance to motion, is less than the reaction forces acting on it. Finally, neither armature or craft will be displaced if the action/reaction forces are insufficient to move either. Applying Newton's second law of motion to the above equation of all internal and external forces acting on a craft, gives:

F_{c-sum}(t)=F_{c}(t)−F_{Rinate}−ƒ_{μsum}(t)−F_{D}=m_{c}a_{c}

Where, m_{c} is the mass of the craft, and a_{c} is the acceleration of the craft. Solving for a_{c}. (t), gives:

$${a}_{c} ( t ) = \frac{{F}_{c} ( t ) - {F}_{Rinate} - {f}_{μ sum} ( t ) - {F}_{D}}{{m}_{c}}$$

Integration of the craft's acceleration, with respect to time, gives its velocity sum:

V_{c-sum}(t)=∫₀^{t}a_{c}dt

As noted previously and as expressed above, during the independent propulsive phase, recoil (thrust), i.e. propulsion, of a mass driver such as a firearm occurs only while a projectile is being driven within a gun barrel, rail, or coil, which constitute the respective propulsive control volumes, where the net rate of change of momentum is always equal to zero. Simultaneously, each counter balance rotates, opposite to each other, such that their combined center of mass, always counter balances the radial motion of the reaction mass.

After the craft has been accelerated, and upon being ejected from the muzzle, with some muzzle velocity, the reaction mass's motion is no longer subject to the accelerative action/reaction forces imparted upon it in the mass driver. Instead, it is now in free flight, and driven independently by the kinetic energy imparted upon it and its associated innate inertia. In the ordinary course of events such a projectile would continue in flight until it came to a stop. However, one can imagine a fired light weight reaction mass, encountering a totally separate and independent head wind, which forces it back into the mass driver, where it could be re-fired. This head wind in the present invention is the rotational system, which independently and apart from the propulsive system, drives the reaction mass back into the mass driver for reuse, without compromising the acceleration gains of the craft achieved during the propulsive phase.

During the rotary phase, as shown experimentally and noted above, the prevailing rotational forces, which, do not affect the linear motion of the craft, eventually bring the reaction mass to a fleeting turn-around stopping-point, and proceed, during the terminal ballistic phase, to drive it back to its home breech of the mass driving device. At that point the system resets for the next firing cycle.

When properly configured, a craft equipped with suitable IMA rotary propulsion engines could produce lift and thrust, and execute roll (rotation about the x-axis), pitch (rotation about the y-axis), and yaw (rotation about the z-axis) maneuvers. In addition, similar to helicopters these engines could facilitate advanced maneuvers, including vertical take-off and landing, hovering, and the ability to fly forward, backward, and laterally.

In the preferred embodiment of the invention, two railguns, located on the outer perimeters of two counter rotating discs fire armatures inwardly whereupon rapid rotation of the two discs commences, one rotating clockwise and the other rotating counterclockwise, and both armatures are ultimately driven back into the breeches of their respective railguns through rotational forces. The rotary propulsion engine can consist of two basic variants: The first variant may be known as a single propulsion unit whereas the second variant may be known as the dual propulsion unit. Both variants employ the use of recoil as a primary means of propulsion whereas the dual propulsion unit uses the kinetic energy of a reaction mass to generate an impulse force, which further drives the craft.

### BRIEF DESCRIPTION OF THE DRAWINGS

The invention directed by way of example, and not by way of limitation, in the figures of the accompanying drawings and in which like reference numerals refer to similar elements and in which:

FIG. 1 is a perspective drawing of a rotary propulsion engine in accordance with an embodiment of the invention.

FIG. 2 is a side view of a rotary propulsion engine in accordance with an embodiment of the invention.

FIG. 3 is top sectional view of a single disc of a rotary propulsion engine employing the single propulsion variant in accordance with an embodiment of the invention.

FIG. 4 is a top sectional view of a single disc of a rotary propulsion engine employing the single propulsion variant represented at time t=0 in accordance with an embodiment of the invention.

FIG. 5 is a top sectional view of a single disc of a rotary propulsion engine employing the single propulsion variant represented at time t=1 in accordance with an embodiment of the invention.

FIG. 6 is a top sectional view of a single disc of a rotary propulsion engine employing the single propulsion variant represented at time t=2 in accordance with an embodiment of the invention.

FIG. 7 is a top sectional view of a single disc of a rotary propulsion engine employing the single propulsion variant represented at time t=3 in accordance with an embodiment of the invention.

FIG. 8 is a top sectional view of a single disc employing the dual propulsion variant of the rotary propulsion engine in accordance with an embodiment of the invention.

FIG. 9 is a top sectional view of a single disc of a rotary propulsion engine employing the dual propulsion variant represented at time t=0 in accordance with an embodiment of the invention.

FIG. 10 is a top sectional view of a single disc of a rotary propulsion engine employing the dual propulsion variant represented at time t=1 in accordance with an embodiment of the invention.

FIG. 11 is a top sectional view of a single disc of a rotary propulsion engine employing the dual propulsion variant represented at time t=2 in accordance with an embodiment of the invention.

FIG. 12 is a top sectional view of a single disc of a rotary propulsion engine employing the dual propulsion variant represented at time t=3 in accordance with an embodiment of the invention.

FIG. 13 is a top sectional view of a single disc of a rotary propulsion engine employing the dual propulsion variant represented at time t=4 in accordance with an embodiment of the invention.

FIG. 14 is a top sectional view of a single disc of a rotary propulsion engine's counterbalancing mechanism represented at time t=1 in accordance with an embodiment of the invention.

FIG. 15 represents an experimentally based derivation of the outbound force through kinematic expressions of the dynamic properties of the rotary propulsion engines while a craft is in steady state motion or accelerating or decelerating.

FIG. 16 is a flow chart diagram depicting the method of using the exemplary rotary propulsion engine system.

FIG. 17A is a top view of a spherical craft employing the use of four rotary propulsion engines in accordance with an embodiment of the invention.

FIG. 17B is a top view of a football-shaped craft employing the use of four rotary propulsion engines in accordance with an embodiment of the invention.

Unless otherwise indicated illustrations in the figures are not necessarily drawn to scale.

### DETAILED DESCRIPTION OF THE PREFERRED EMBODIMENTS

Terminology used herein is used for the purpose of describing particular embodiments only and is not intended to limit the scope of the present invention. It must be understood that as used herein and in the appended claims, the singular forms “a,” “an,” and “the” include the plural reference unless the context clearly dictates otherwise. For example, a reference to “an element” is a reference to one or more elements and includes all equivalents known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Language that may be construed to express approximation should be so understood unless the context clearly dictates otherwise.

Unless defined otherwise, all technical and scientific terms used herein have the same meanings as commonly understood by a person of ordinary skill in the art to which this invention belongs. Preferred methods, techniques, devices, and materials are described. But any methods, techniques, devices, or materials similar or equivalent to those described herein may be used in the practice or testing of the present invention. Structures described herein should also be understood to refer to functional equivalents of such structures.

References to “one embodiment,” “an embodiment,” “various embodiments,” etc., may indicate that the embodiment(s) of the invention so described may include particular features, structures, or characteristics. However, not every embodiment necessarily includes the particular features, structures, or characteristics. Further, repeated use of the phrase “in one embodiment,” or “in an exemplary embodiment,” do not necessarily refer to the same embodiment although they may. A description of an embodiment with several components in communication with each other does not imply that all such components are required. On the contrary, a variety of optional components are described to illustrate the wide variety of possible embodiments of the present invention.

A “computer” may refer to one or more apparatus and/or one or more systems that are capable of accepting a structured input, processing the structured input according to prescribed rules, and producing results of the processing as output. Examples of a computer may include a stationary and/or portable computer; a computer having a single processor, a computer having multiple processors, or a computer having multi-core processors, which may operate in parallel and/or not in parallel; a general purpose computer; a supercomputer; a mainframe; a super mini-computer; a mini-computer or a workstation.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

“Software” may refer to prescribed rules and/or instructions used to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium employing software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “guidance system” is a physical device, or a group of devices implementing a guidance process used for controlling the movement of a ship, aircraft, missile, rocket, satellite, or any other moving object. Guidance is the process of calculating the changes in position, velocity, attitude, and/or rotation rates of a moving object required to follow a certain trajectory and/or attitude profile based on information about the object's state of motion.

As is well known to those skilled in the art, many careful considerations and compromises typically must be made when designing for the optimal manufacture of a commercial implementation of such rotary propulsion engines. A commercial implementation in accordance with the spirit and teachings of the invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art.

The exemplary rotary propulsion engines will now be described in detail with reference to embodiments thereof as illustrated in the accompanying drawings.

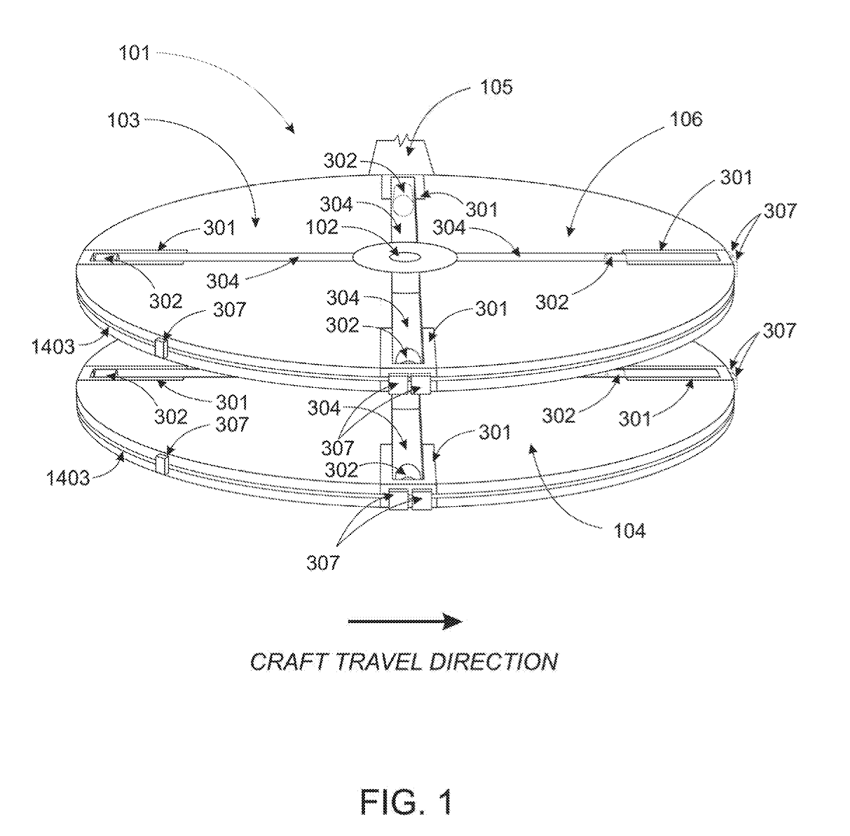

FIG. 1 represents a perspective drawing of the exemplary rotary propulsion system in accordance with an embodiment of the invention. In this perspective view, no cover over the individual discs of the disc assembly is shown so as to better illustrate the invention's inner components. The propulsion system includes a counterrotating disc assembly 101 which is comprised of an upper disc 103 and a lower disc 104. Each disc is positioned directly superior and inferior of one another and are axially configured to one another by an axle assembly 102. As depicted using arrows in FIG. 1, the upper disc 103 is configured to rotate counterclockwise and the lower disc 104 is configured to rotate clockwise. However, each disc can be made capable of rotating in either direction in concert with its counter rotating disc. In various embodiments of the present invention, the disc assembly includes a connection assembly 105 capable of attaching the disc assembly to a spacecraft or other craft. The connection assembly 105 also serves as the power supply and telemetry conduits. Persons skilled in the art will recognize that such a connection assembly is capable of being configured and connected to the disc assembly 101 in numerous ways.

In one embodiment of the invention, both the upper and lower disc assemblies contain four mass driver and counterbalance assemblies 106 spaced equally apart from one another at ninety-degree angles. A mass driver, for purposes of definition, is technically any device used to propel a ballistic reaction mass or armature in a known direction. Each mass driver and counterbalance assembly consists of a mass driver 301, a reaction mass 302, a travel path for the reaction mass 304, and a counterbalancing mechanism consisting of two pivoting counterweights 307. The counterweights, as depicted, travel along a track 1403 circling each disc. Differing numbers and varieties of mass driver and counterbalance assemblies may be used so long as each disc maintains a torque balance about its axis of rotation, as represented by the axle assembly 102.

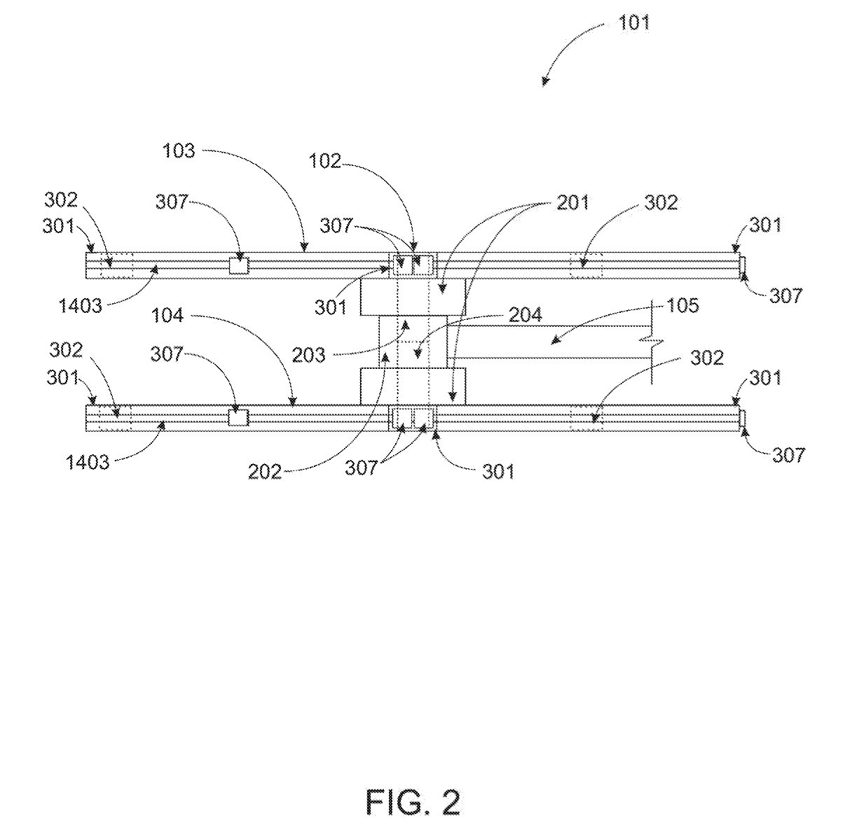

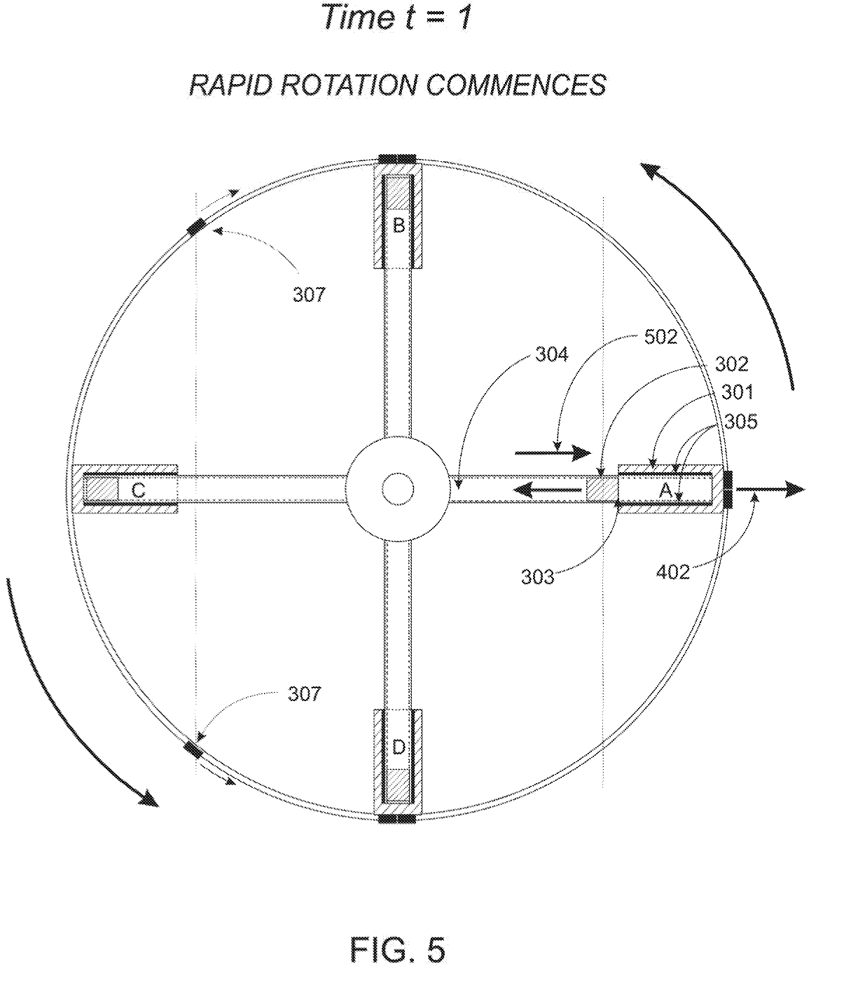

FIG. 2 represents a side view of the exemplary propulsion system as depicted in FIG. 5. In this view, the disc assembly 101 consists of an upper disc 103 and a lower disc 104. In one embodiment, the upper disc and lower disc are rotatably connected by an axle assembly 102 consisting of an upper axle 203 and a lower axle 204. Positioned in the center of the disc assembly and around the center of the axle assembly is a protective cover 202 which also serves as a housing for bearings, etc. and a mounting point for the connection assembly 105 to attach to a spacecraft or other craft. Rotation of each axle is achieved through a drive mechanism means such as, but not limited to, electric motors 201 and radial solenoids.

It will become readily apparent to persons skilled in the art that the drive mechanism may be governed by a guidance system employing computer or microprocessor means of regulating rotational acceleration and velocity of each disc assembly. It will become further apparent to those skilled in the art that each drive mechanism 201 may be powered through electromagnetic means. Represented by dashed lines are the reaction mass or armatures 302, both in motion and nestled in the breech of a mass driver 301. Further represented are counterweights 307 and a track 1403 which will be described in greater detail in the subsequent drawings.

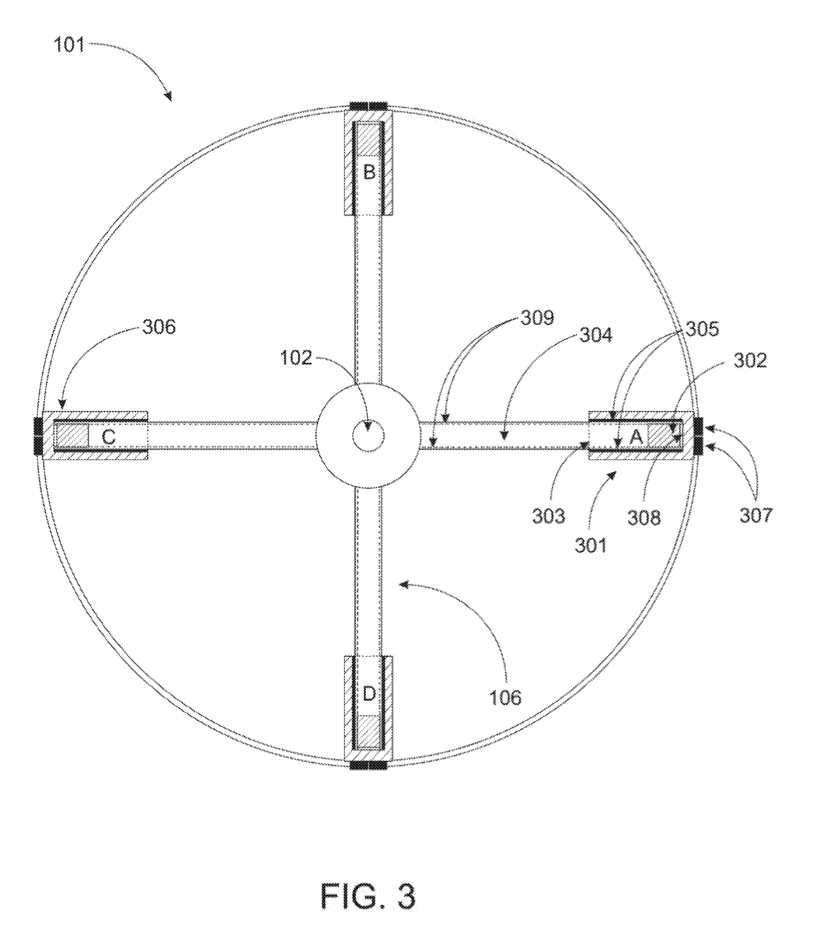

FIG. 3 represents a top sectional view of one disc of the disc assembly employing the single propulsion variant 101. The upper disc 103 and lower disc 104 are identical in configuration and function. The principal difference between the two are that the upper disc rotates in one direction while the lower disc rotates in the opposite direction. The primary purpose of utilizing counterrotating discs is to provide a counteracting mechanism for the torque created when each disc rotates, as to maintain rotational equilibrium in the system. The disc serves primarily as a frame for the mass driver assemblies and can be comprised of numerous materials and constructed according to numerous methods, such as, but not limited to, a strong metal frame with an outer cover.

The disc assembly is rotatably connected at the center of each disc by the axle assembly 102. FIG. 3, for example, depicts four mass-driver and counter balance assemblies 106 spaced apart equally at ninety-degree angles. Each mass-driver is labeled A, B, C and D for illustrative purposes.

In the preferred embodiment of the invention, the mass-driver 301 utilized is a specialized railgun. However, numerous other mass-drivers may be employed. For example, but in no way limiting, the mass drivers may employ a chemical propellant, compressed gas propellant, a spring action, or an electromagnetic coil gun mechanism. It should be noted, that for spacecraft utilizing chemical propellants, these propellants should be recyclable in situ, such as the bipropellant oxygen/hydrogen, or the monopropellant hydrogen peroxide, and such.

Each railgun is constructed of at least two parallel metallic rails of known length 305, which are connected to power supplies engineered to drive a magnetically susceptible solid reaction mass or armature 302 of a known mass along a travel path 304. The travel path 304 may be fitted with rails or grooves 309 to maintain the direction of a travelling reaction mass as it moves along the travel path 304. Each railgun essentially consists of two parallel metal rails connected to pulsed power supplies such as, but not limited to, capacitors and/or self-excited, air-core compensated pulsed alternators, and the like. Such types of power supplies are capable of repeatedly generating high-power outputs over short time cycle intervals. Current delivered to each rail may be governed through a guidance system employing microprocessor and transformative means thereby governing the velocity of the reaction mass or armature 302. The supplied electric current makes the railgun behave as an electromagnet, creating a magneticfield inside the loop formed by the length of the rails up to the position of the reaction mass or armature. It is this magnetic field which propels the reaction mass 302 along the conducting rails. In various embodiments of the invention, conducting and non-conducting rail sections can be switched on an off as needed by a guidance system to propel the reaction mass 302 with a known acceleration rate to achieve a desired recoil force. The conducting rails range from the armature loading area 308, here to be referred to as the breech chamber, to the muzzle end of the railgun, where the armature, is ejected, with some known ejection muzzle velocity, into the travel path 304.

Each mass-driver assembly 106 may be configured in numerous ways to accommodate armatures of varying sizes, shapes and masses. For example, each mass-driver assembly could be cylindrical in nature with a spherical reaction mass. In other embodiments, the mass-driver assembly could be angular to accommodate a rectangular reaction mass.

Each mass driver assembly 106 is equipped with a counterbalancing mechanism consisting of a pair of counterweights 307 which maintain the rotating disc's center of mass about its axis 102. Whenever a reaction mass or armature is nestled in the breech of its corresponding railgun assembly, the counterweights are nestled at the periphery of the breech end 308 of the opposing mass driver assembly 306 (In this drawing, the opposing mass driver assembly is labeled C). When a reaction mass or armature 302 is displaced from the breech, the counterweights pivot circumferentially through powered track means, radial motorized rods, or mechanisms linked to the armature, all of which are precluded from interacting with the linear motion of the craft. The counterweights travel along a circumferential path in such a manner so as to maintain a balanced distribution of masses about the axis of rotation in order to maintain a zero-horizontal torque sum as the armature moves along its ballistic trajectory along the conducting rails 301 and the travel path 304 while the disc assembly rotates. Persons skilled in the art will readily appreciate that such a counterbalancing mechanism could be governed by a guidance system employing computer-based algorithms to calculate the dynamic properties of the counterweights.

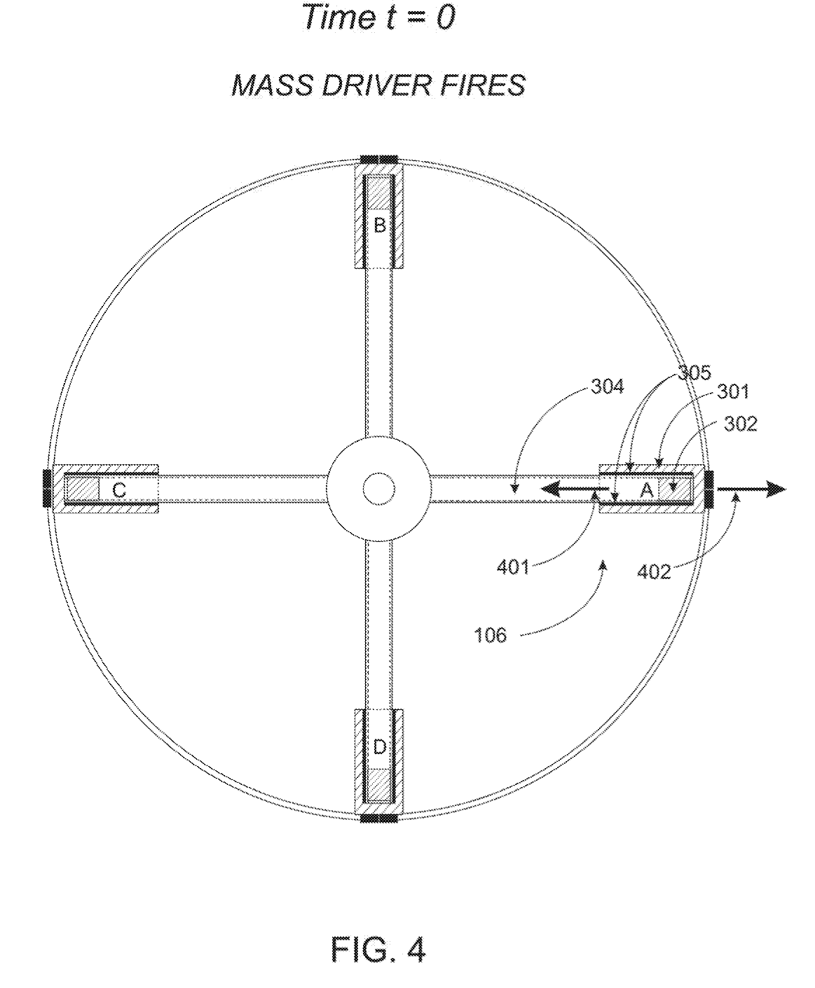

The operation of the exemplary propulsion system commences in a craft that is at rest or under steady state motion at some time t=0, as depicted in FIG. 4. The drive mechanism 201 is used to align each disc in a specific direction, in this case, along the x-axis. Electric current is applied to the conducting rails 305 which drives the reaction mass or armature. In this figure, the mass-driver assembly, marked A, is fired in a direction towards the axis of rotation of the disc assembly. When the railgun or mass driver fires with a certain force governable through known means, the reaction mass 302 is driven in a vector 401 through the conducting rails of the railgun 301 and ultimately along the travel path 304 represented along the x axis of the figure.

Meanwhile, in accordance with Newton's Third Law of Motion, a recoil or reaction force is exerted on the disc assembly 101 in a direction opposite of that of the reaction mass 402. In other words, while the armature or reaction mass, once fired from the mass driver, travels along the x-axis in the negative direction, the rotary propulsion engine, and the craft being driven by said propulsion engine, is driven along the x-axis in the positive direction.

At time t=1, as represented in FIG. 5, the armature or reaction mass 302 has reached the muzzle end 303 of the conducting rails 301 of the railgun assembly. At the muzzle end 303, the kinetically charged armature or reaction mass 302 is injected into the electromagnetically inactive or non-conducting travel path 304 with a known muzzle velocity whereupon each disc 101 commences rapid rotation. It is readily known to persons having skill in the art that a wide variety of methods are available to trigger the rapid rotation as the reaction mass passes the muzzle. Such means may include, but are not limited to, sensors and relays connected to a guidance system employing microprocessor or computer-based telemetry systems.

The rotating disc maintains its balance while the reaction mass is in motion through a counterbalancing mechanism. In the preferred embodiment, the counterbalances operate circumferentially in nature. The counterbalancing mechanism comprises two counterweights 307 located 180° from the breech of each firing mass driver. For ease of understanding and illustrative purposes, the two counterweights as referenced in the rotary propulsion engine's cycle are represented as being side-by-side when in a resting position. In certain embodiments, the counterweights may be moved through powered track means, radial motorized rods, or mechanisms linked to the armature. All of which are precluded from interacting with the linear motion of the craft. When the mass driver fires, the reaction mass moves inward towards the center of the disc assembly. Concurrently, the counterbalancing mechanism maintains dynamic internal torque equilibrium of each disc by moving, or pivoting, the two counterweights about the circumference of the disc. The center of mass of the counterweights is maintained such that their torque is always equal and opposite, along the rails, to the torque of the moving armature. This center of mass is represented through the use of dashed lines which vertically bisect both the reaction mass or armature 302 and the counterweights 307.

During the rotary propulsion engine's cycle, a guidance system employing computer-based algorithms are used to most effectively calculate the armature's dynamic properties throughout the process. Such algorithms continuously evaluate the armature's position and velocity along the conducting railgun and travel path. Through the use of sensors and by computationally parsing the travel time of the armature from the muzzle towards the axis of rotation, said algorithms can adjust the rotational velocity of the disc assembly through powering the drive mechanism 201. Maneuverability of a craft configured with the radial propulsion engines is achieved through timely and directional firing of the active mass-driver assembly 106.

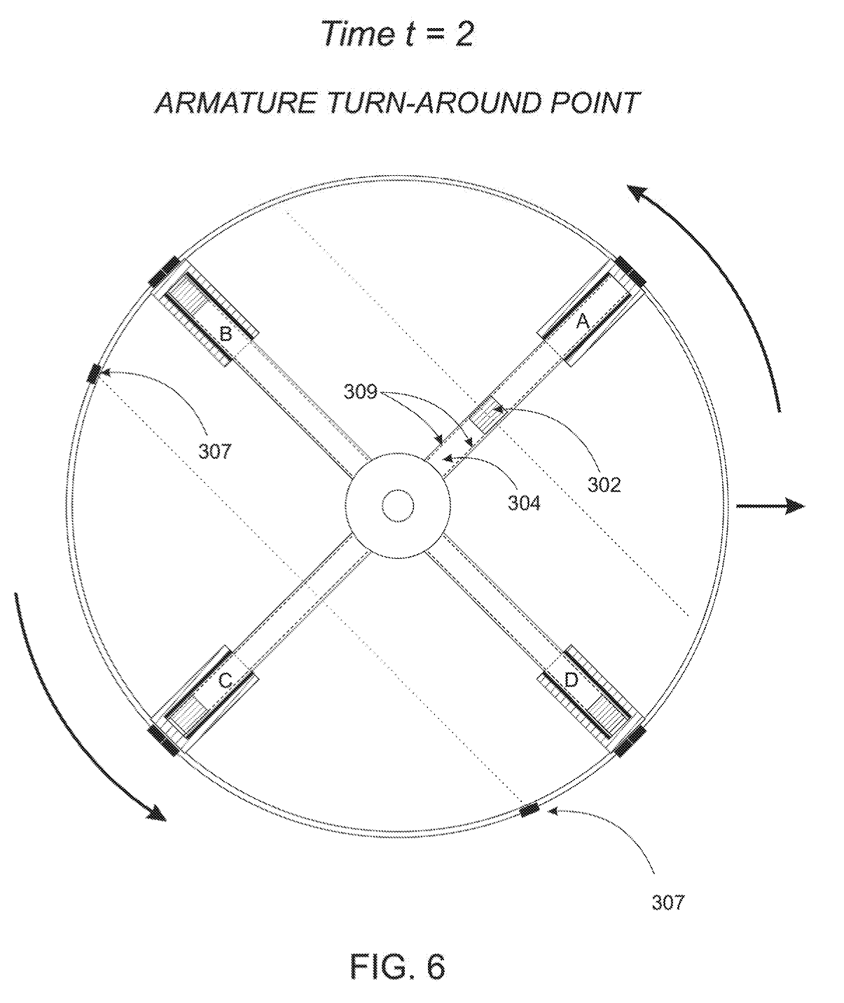

In a high-speed rotational environment, the outbound rotational and frictional forces 502 will ultimately forestall the velocity of the reaction mass or armature as it travels inwardly along the travel path 304, the frictional forces arising from contact with the rails or grooves 809. Under the influence of both outbound and frictional forces 502, the armature or reaction mass is brought to a halt as depicted in FIG. 6.

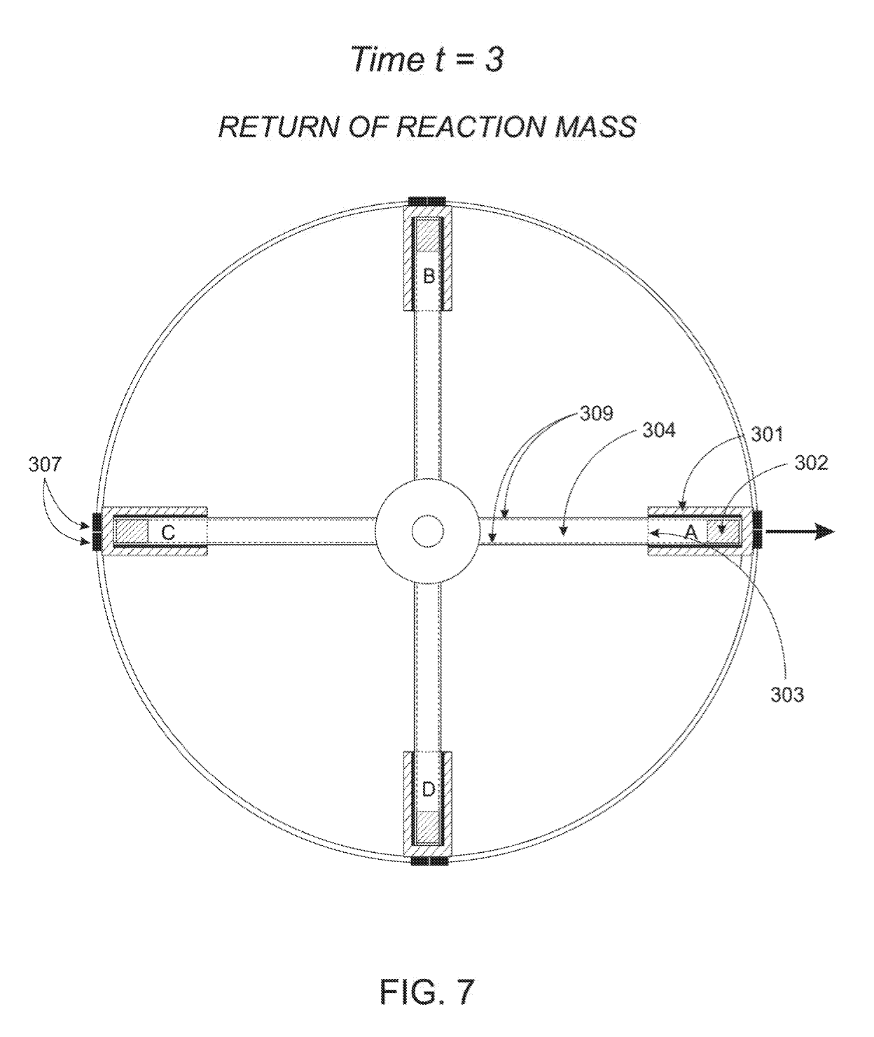

When the reaction mass or armature is brought to a halt, it may be permitted to rebound immediately, or alternatively, it may be held harmlessly in place by numerous means such as, but not limited to, a rail locking mechanism, and released, such that it reenters the breech chamber, as depicted in FIG. 7, when the rotating disc aligns with the travel path of the craft. This collision with the breech chamber is tangential in nature, which can only affect the attitude of the craft but not its linear displacement. However, since counter-rotating disc pairs are always in operation, these tangential collisions cancel each other out with no rotational effect on the craft. It should be noted that because of the relatively low coefficient of friction incurred, the effect on the craft's motion is not only relatively minimal, but also essentially cancels during the complete inbound and outbound cycle.

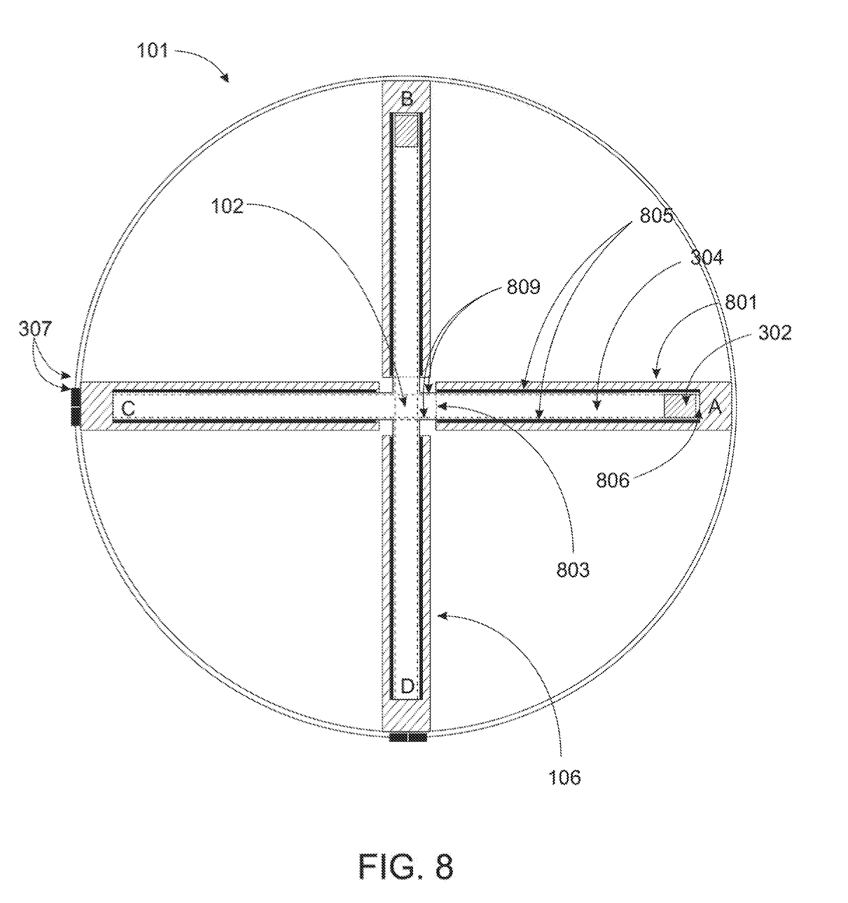

FIG. 8 represents a top sectional view of one disc of the disc assembly employing the dual propulsion variant, where the rails run the diameter of the disc. In this configuration, the initial recoil or thrust imparted on the craft during the propulsive phase is the same as with the single propulsion case. In addition, the disc rapidly rotates through 180° rotation, upon the armature's ejection from the muzzle, aligning the rails along the x-axis, which is coincident with the craft's flight path trajectory, whereupon the armature inelastically strikes the opposing breech C. This collision brings about a second driving or impulse force, which accelerates the craft further. The dual propulsion disc appears outwardly similar to 101. Identical in nature to FIG. 3, the disc 101 serves primarily as a frame for the mass driver assemblies and can be comprised of numerous lightweight but strong materials. An engine may contain as many disc pairs as practical. As with the single propulsion variant, each mass-driver is labeled A, B, C and D for illustrative purposes.

The disc assembly 101 is axially and rotatably connected at the center of each disc by an axle assembly 102. In contrast to FIG. 3, and the single propulsion variant, the axle is situated beneath the intersection of the mass driver assembly's travel paths 304. As depicted in FIG. 8, two mass-driver and counter balance assemblies 106 are spaced apart equally at ninety degree angles. In alternate embodiments of the invention, various number of mass drivers may be utilized, as long as they are symmetrically distributed, and can be physically accommodated.

As in the single propulsion variant, the preferred mass-driver utilized is a standard railgun. However, numerous other mass-drivers as referenced above may be employed as well. And just as with the single propulsion variant, each railgun is constructed of at least two conducting metallic rails of known length 805, which are engineered to drive a magnetically susceptible solid reaction mass or armature 302 of a known mass. The conducting rails range from the reaction mass loading area 806, here to be referred to as the breech chamber, to the muzzle 803 end located, as determined computationally, near or about the axis of rotation where non-conducting rails take over. The reaction mass is fired along a travel path 304 towards the center of the disc assembly. The travel path 304 may be fitted with rails or grooves 809 to maintain the direction of a travelling reaction mass as it crosses the axis of rotation of a moving disc.

Just as with the single propulsion variant, each mass driver assembly 106 is equipped with a pair of counterweights 307 which maintain the rotating disc's center of mass along its rotational axis as referenced by the axle assembly 102. Whenever a reaction mass or armature is nestled in the breech of its corresponding railgun assembly, the counterweights are nestled at the periphery of the breech end of the opposing railgun assembly (The opposing railgun assembly is labeled C in this particular illustration). For ease of understanding and illustrative purposes, the two counterweights as referenced in the rotary propulsion engine's cycle are represented as being side-by-side when in a resting position. When a reaction mass or armature 302 is displaced from the breech, the counterweights pivot circumferentially via a motorized or tracked means along the circumference of the disc 101. The counterweights 307 travel along a circumferential path in such a manner so as to maintain a balanced distribution of masses about the axis of rotation in order to maintain a zero horizontal torque sum as the armature moves along its ballistic trajectory along the conducting rails 801 and the travel path 304 while the disc assembly rotates.

As this variant shall be using the kinetic energy of the reaction mass' collision with the opposing breech, the breech units 806 in this variant may be reinforced through means such as, but not limited to, thicker and stronger materials as well as thicker and stronger fastening methods. In the preferred embodiment of the invention, whenever a reaction mass or armature is nestled in the breech of its corresponding railgun assembly, the counterweights are nestled in the breech end 806 of the opposing railgun assembly. Just as in the single propulsion variant, when a reaction mass or armature 302 is displaced from the breech, the counterweights pivot circumferentially via a motorized or tracked means along the circumference of the disc 101. The counterweights travel along the circumference in such a manner so as to maintain a balanced torque distribution of masses as the armature moves along its ballistic trajectory down the conducting 801 and nonconducting rails. In other words, the center of mass of the counterweights is maintained such that their torque is always equal and opposite, along the rails, to the torque of center of mass of the moving armature.

As with the single propulsion variant, the dual propulsion variant employs a guidance system employing computer-based algorithms and sensors to most effectively monitor and calculate the armature's dynamic properties throughout the process. Such sensors and algorithms continuously evaluate the reaction mass or armature's position and velocity along the rail assembly. Through the use of sensors and by computationally parsing the travel time of the armature along its travel path, said algorithms can adjust the acceleration and travel velocity of the reaction mass during the propulsive phase, as well as the rotational velocity of the disc assembly during the revolving phase. All along the cycle, the reaction mass is continuously guided and monitored by a guidance system means employing algorithms and computer modeling programs which take account, among others, of such parameters, as propulsive forces, muzzle velocity, frictional and rotational forces, counterbalancing, as well as the state of acceleration or steady state motion of the craft.

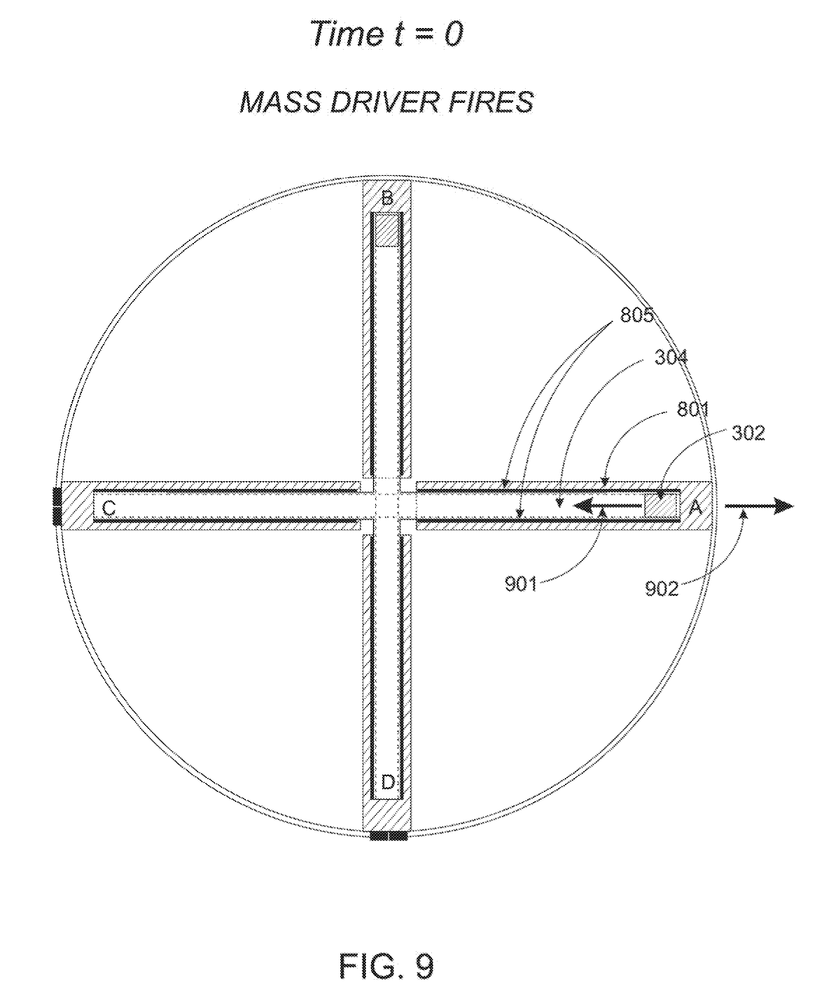

The dual propulsion variant's cycle commences at some time t=0 as depicted in FIG. 9. As with the single propulsion variant, electric motors or radial solenoids 201 are used align the disc in a specific direction. And once again, maneuverability of a craft configured with the radial propulsion engines is achieved through timely and directional firing of the active mass-driver assembly 106. When the railgun or mass driver fires with a certain force governable through known means, the reaction mass 302 is driven in a vector 901 through the conducting rails 805 of the railgun 801 and ultimately towards the travel path 304 represented along the x axis of the figure.

Just as with the single propulsion variant, a recoil or reaction force is exerted on the disc assembly 101 in a direction opposite of that of the reaction mass 902. The recoil or reaction force is the propulsive force which ultimately drives the craft employing the rotary propulsion engines. In other words, the force acting on the reaction mass or armature is accompanied by an equal and opposite reaction or recoil force acting on the breech of the mass driver, which ultimately propels the craft.

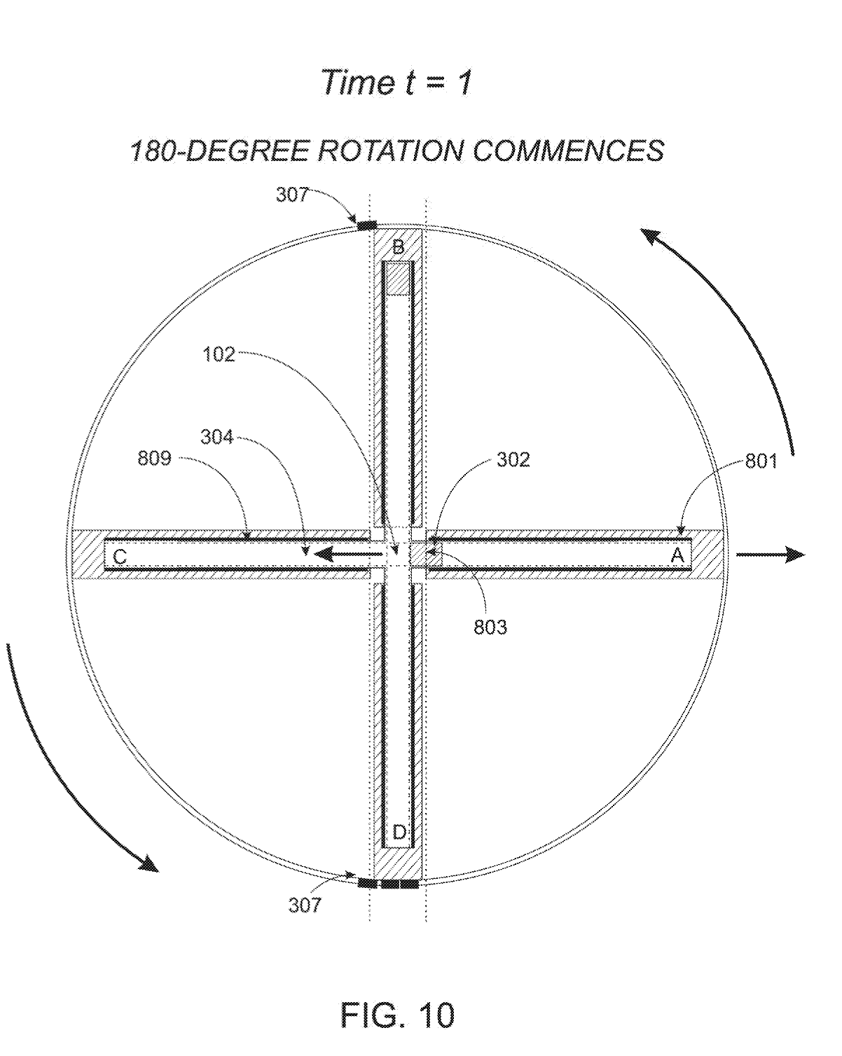

At time t=1, as represented in FIG. 10, the armature or reaction mass 302 has reached the muzzle end 803 of the conducting rails 801 of the railgun assembly. At the muzzle end 803, the armature or reaction mass 302 is introduced into the electromagnetically inactive inner rail portion 304 with a known muzzle velocity whereupon each disc 101 commences rapid rotation. Just as with the single propulsion variant, it is readily known to persons having skill in the art that a wide variety of methods to trigger the rapid rotation as the reaction mass passes the muzzle. Such means may include, but are not limited to, sensors and relays networked to a microprocessor or computer-based guidance system means.

Each rotating disc maintains its balance while the reaction mass is in motion through a dynamic torque counterbalancing mechanism. In the preferred embodiment, the counterbalances operate circumferentially in nature. The counterbalancing mechanism comprises two counterweights 307 located 180° from the breech of each firing mass driver. In certain embodiments, the counterweights may be moved through powered track means, radial motorized rods, or mechanisms linked to the armature. All of which are precluded from interacting with the linear motion of the craft. When the mass driver fires, the reaction mass moves along the rails towards the center of the disc assembly. The counterbalancing mechanism continuously maintains dynamic internal torque equilibrium of each disc by moving, or pivoting, the two counterweights about the circumference of the disc. In other words, the center of mass of the counterweights is maintained in such a way that their torque is always equal and opposite along the rails to the torque of the center of mass of the moving armature. The counterweights 307 travel circumferentially about the axle assembly or axis of rotation 102 in such a manner so as to maintain a balanced distribution of masses about the axis of rotation in order to maintain a zero horizontal torque sum as the armature moves along its ballistic trajectory. This is represented through the use of dashed lines which vertically bisect both the reaction mass or armature 302 and the counterweights 307.

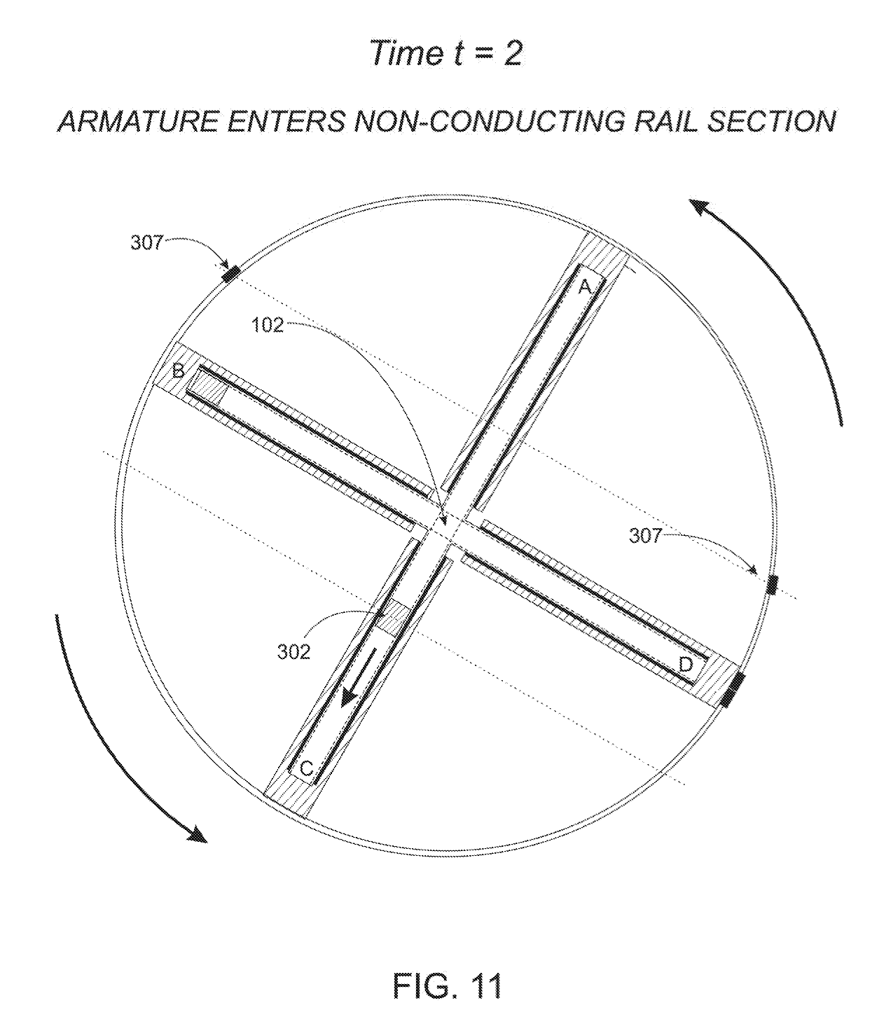

FIG. 11 is representative of the disc assembly at time t=2 having rotated 60° counterclockwise, for illustrative purposes, with the reaction mass or armature having crossed the axle assembly or axis of rotation 102. The reaction mass 302 travels along the non-conducting rails past the axis of rotation towards the opposing breech of the opposing mass driver assembly C, and is now travelling outwardly with enhanced velocity due to outward rotational forces acting on it. As the armature is in route, the counterweights 307 have rotated along the circumference of the disc so as to create a torque counterbalance to the traveling reaction mass while the disc rotates. This is represented through the use of dashed lines which vertically bisect both the reaction mass or armature 302 and the counterweights 307.

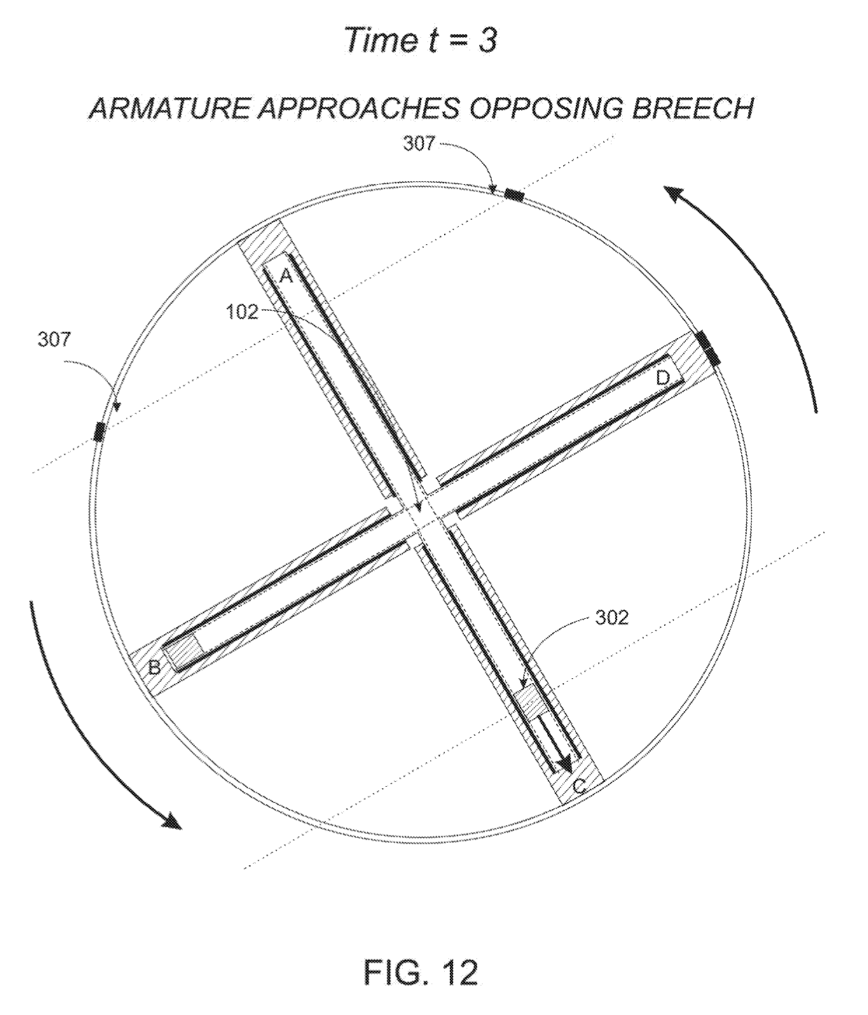

FIG. 12 is representative of the disc assembly at time t=3 having rotated 120° counterclockwise with the reaction mass or armature approaching the opposing breech end of the mass driver assembly. The reaction mass 302 has crossed the axis of rotation 102. As the armature is in route, just as in FIG. 10 and FIG. 11, the counterweights 307 have rotated along the circumference of the disc so as to create a torque counterbalance to the traveling reaction mass while the disc rotates. This is represented through the use of dashed lines which vertically bisect both the reaction mass or armature 302 and the counterweights 307.

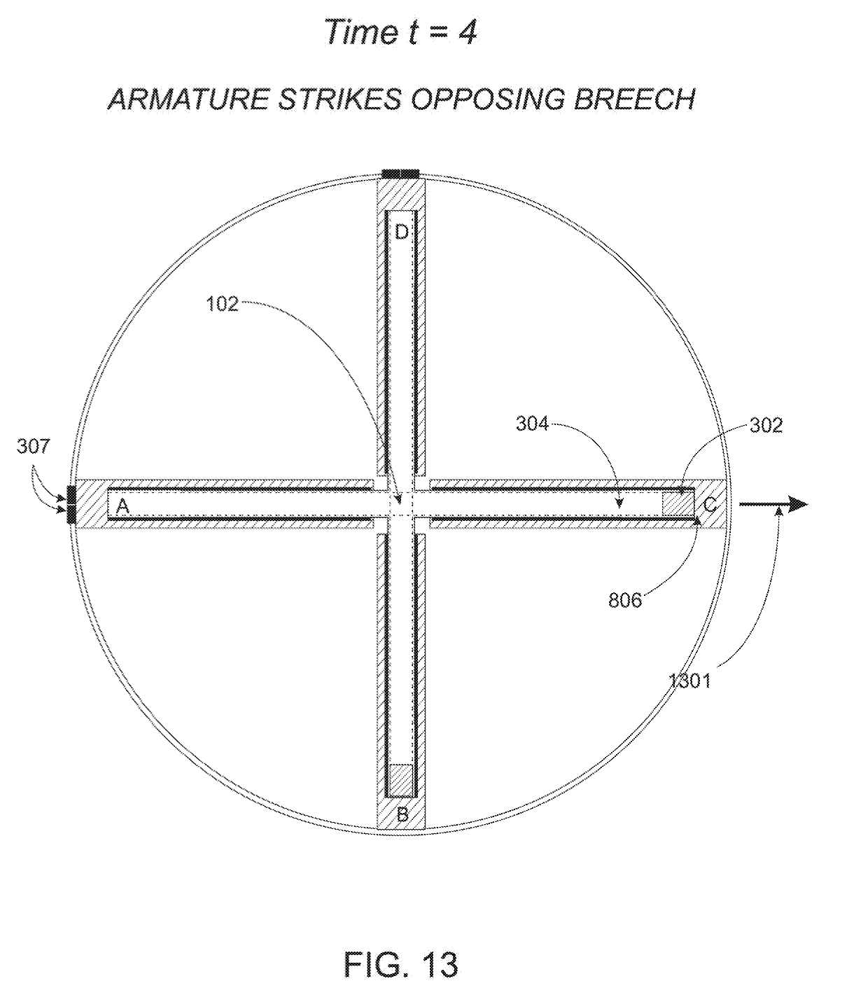

FIG. 13 represents a dual propulsion variant's cycle concluding at time t=4 with the reaction mass 302 striking the breech end 806 of the mass driver assembly directly opposite from the firing mass driver after its parent disc completes its 180° rotation. The vector of the kinetic energy 1301 is in the same direction as the recoil force produced when the mass driver fired. This collision generates a second driving force, an impulse force, which further accelerates the associated craft. Mass driver C may, after activating itself and its rails, fire to further accelerate the craft or the ready to fire mass driver B may be rotated into the desired firing position and fired. Maneuverability of a craft employing the rotary propulsion engines can be accomplished by aligning and firing the mass drivers in the desired direction. This second force, acting on the craft is an impulse force, and may be given as:

$${F}_{j} = \frac{{m}_{p} {V}_{j} ( t )}{{t}_{j} 2 - {t}_{j} 1}$$

Where Fⱼ is the impact impulse force applied during some empirically observable time span tⱼ1→tⱼ2, mₚ is the mass of the reaction mass or armature (projectile), and Vᵢ(t) represents the impact velocity on the opposing breech.

The motion of the armature, during craft steady state motion and accelerative motion, may be determined by utilizing mathematical treatments and computer models, analogously to those employed in the single propulsion propulsion variant. In this case also, due to the complexity associated with the armature's motion, a guidance system employing computer-based algorithms is utilized to most effectively calculate the propulsion system's components, and the craft's interrelated motions. These models and associated mathematical treatments, successively evaluate the craft's and armature's motion along the non-rotating and rotating rails, by computationally parsing the travel time, in the respective quadrants, into set minuscule known time periods, and solving them sequentially. These mathematical and computational treatments may be applied here, by persons skilled in the art, in an analogous fashion that employed in the analysis of the single propulsion system.

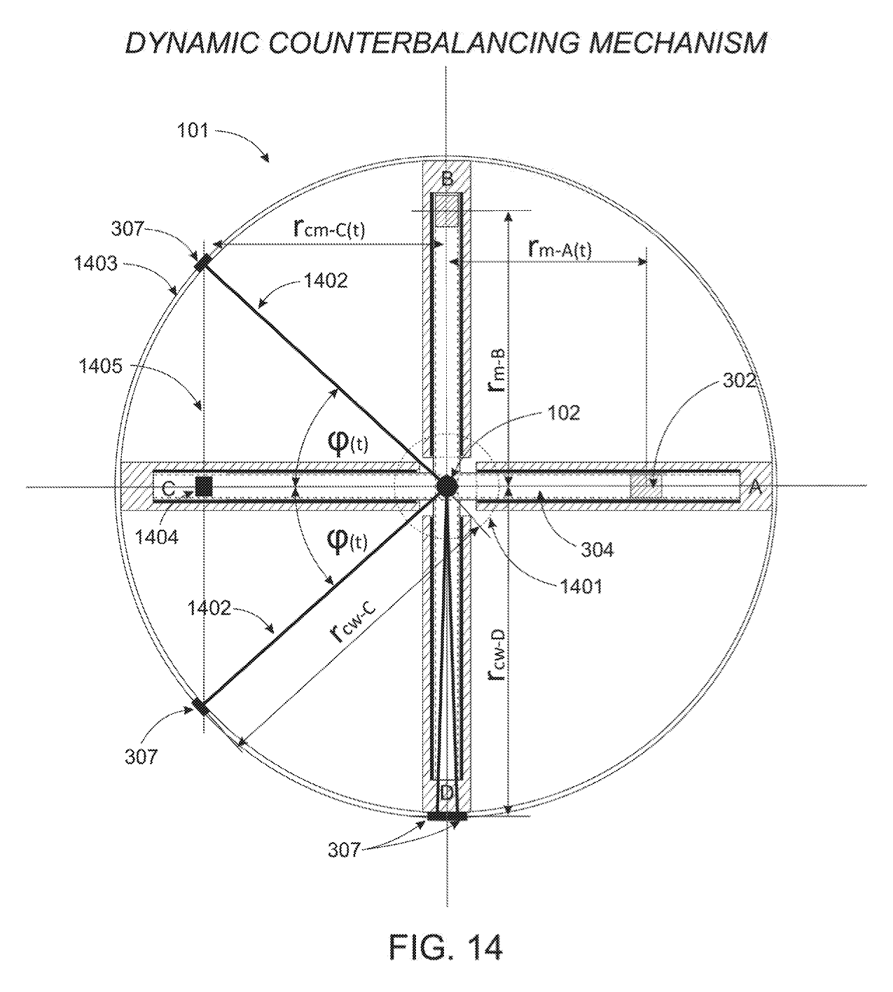

FIG. 14 represents, for illustrative purposes, a top-view depiction of the dual propulsion variant's dynamic counterbalancing as the reaction mass or armature moves along the travel path 304 as a function of time. The counterbalancing mechanism is rotational in nature, and the means for rotating the counterweights 307 about the circumference of each disc, in this version, is an electric motor. In the embodiment depicted in FIG. 14, radial arms 1402, of length r_{cw-c}, connect each electric motor to each of the counterweights. Each electric motor is housed in a motor assembly 1401 located around the disc's axis of rotation 102. When a reaction mass or armature 302 travels along its travel path 304 the counterweights pivot circumferentially. In this embodiment, for illustrative purposes, the counterweights 307 are in a side-by-side configuration as illustrated in FIGS. 3-13. In other embodiments, the counterweights can be configured to travel along a track 1403 through various means.

The counterweights 307 travel circumferentially in such a manner so as to maintain a balanced distribution of masses about the axis of rotation in order to maintain a zero horizontal torque sum as the armature moves along its ballistic trajectory. The length of the radial arms 1402 can be adjusted along with the masses of the respective counterweights 307 to produce the same or similar horizontal torque sums. The counterbalancing mechanism employs a guidance system employing sensors and computer-based algorithms to most effectively calculate the moving armature's dynamic properties throughout the process and move the counterweights 307 in such a manner where the center of mass remains about each disc's 101 axis of rotation 102. In other embodiments, the counterweights can be moved about the circumference of each disc through a motor and track mechanism located along the circumference of each disc 101.

With reference to FIG. 14, depicted is a single disc assembly 101, which encompasses four mass-driver and counterbalance assemblies labeled A-D, with hatched line cross over about axis of rotation region 102, to permit transition of the reaction mass from one end of the disc to the other. First to be examined will be the status of vertical rails B and D, extending from the periphery to the axis of rotation 102, as viewed from the top. The peripheral breech chamber of rail B, houses the reaction mass or armature 302, of mass m_{p-B}, whose weight, pushes downwards, and is located at some radial distance r_{m-B} from the axis of rotation 102. On the opposite side, at the circumference of the disc, on a track or groove, outside of breech D, is positioned a counterweight 307, at distance r_{cw-D} from the fulcrum, of total mass m_{cw-D}, composed of equal two halves 307, also pushing downwards. In order to balance each other out, and produce a zero horizontal torque sum Στ about the axis of rotation, the following equilibrium condition must be met:

Στ=r_{m-B}×m_{p-B}−r_{cw-D}×m_{cw-D}=0

Where “×” is the cross product, meaning that the radial arm of the rail and downward force of the respective masses, are perpendicular to each other. This relationship may be restated as:

r_{m-B}×m_{p-B}=r_{cw-D}×m_{cw-D}

Since r_{m-B}, m_{p-B}, and r_{cw-D} are known quantities, the mass of the counterweight m_{cw-D}, may be given as:

$${m}_{cw - D} = \frac{{r}_{m - B} {m}_{p - B}}{{r}_{cw - D}}$$

Attention will next be directed towards mass-driver and counterbalance assemblies A and C. Here, reaction mass m_{p-A}, has been driven from the peripheral breech chamber A, and is, at the time in question, located at some distance r_{m-A}(t), along the x-axis, from the fulcrum, which would have created a horizontal state of imbalance with respect to mass-driver and counterbalance assembly C, were it not for the counterbalancing mechanism in play, as shall be presently described. At the time in question, reaction mass A, is, located at some distance r_{m-A}(t), as a function of time, from the axis of rotation. The balancing system counter acts this asymmetric move, by circumferentially rotating the two half counterweights m_{cw-c}. The counterweights are synchronously rotated away from the x-axis, on the outer track or groove, one rotating clockwise and the other rotating counterclockwise. At said time, when reaction mass A is located, at distance r_{m-A}(t), from the axis of rotation, the rotating counterweights counter balance that radial displacement, by in effect placing their combined center of mass 1404, whose mass is equal to the counterweight's 307 mass m_{cw-D}, at a balancing distance from the fulcrum. The counterbalancing mechanism may more easily be explained if one imagines that the counterweights are connected by vertical line 1403, which may be thought of, as a “weightless” beam, symmetrically supporting the two half counterweights at its ends. The midpoint of the beam, intersects the x-axis at a right angle, at some distance point r_{cm-C}(t), as a function of time, from the fulcrum, which is proportional to the reaction mass's distance r_{m-A}(t), as a function of time, from said pivot point.

In order to balance each other out and produce a zero-horizontal torque sum Στ about the axis of rotation, as a function of time, the following equilibrium condition must be met:

Στ=r_{m-A}(t)×(m_{p-A})−r_{cm-C}(t)×(m_{cw-c})=0

Rearranging, the equilibrium state may be expressed here as:

r_{m-A}(t)×(m_{p-A})=r_{cm-C}(t)×(m_{cw-c)}

Where,

$${r}_{c m - C} ( t ) = \frac{( {r}_{m - A} ( t ) ) {m}_{p - A}}{{m}_{cw - c}}$$

Since, m_{cw-c} is equal to m_{cw-D}, this equilibrium may be restated as

r_{m-A}(t)×(m_{p-A})=r_{cm-C}(t)×(m_{cw-D})

Solving for r_{cm-C}(t) gives

$${r}_{c m - C} ( t ) = \frac{{r}_{m - A} ( t ) ( {m}_{p - A} )}{( {m}_{cw - D} )}$$

The rotational angle φ(t) as a function of time, required to be spanned by the counterweights, in order to maintain a zero-horizontal torque sum Στ about the axis of rotation, in response to the reaction mass's travel along the x-axis, may be obtained as follows:

$$cos ϕ ( t ) = \frac{{r}_{c m - C} ( t )}{{r}_{cw - c}}$$

Since r_{cw-c}is equal to r_{cw-D}, the above equation may be restated as:

$$cos ϕ ( t ) = \frac{{r}_{c m - C} ( t )}{{r}_{cw - D}}$$

Solving for φ(t), gives:

$$ϕ ( t ) = {cos}^{- 1} \frac{{r}_{c m - C} ( t )}{{r}_{cw - D}}$$

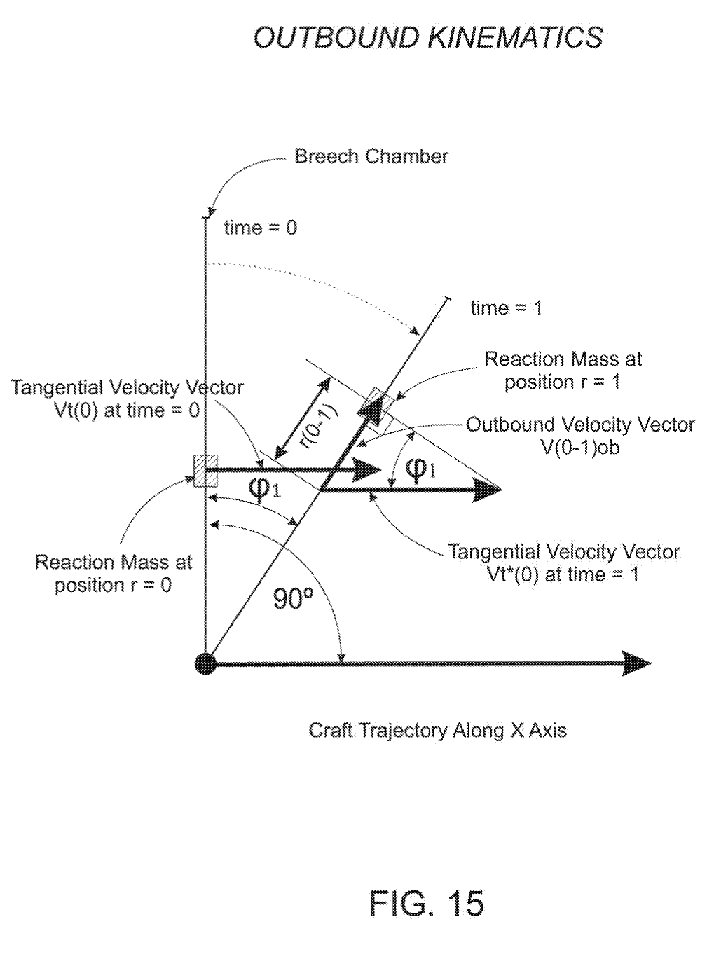

FIG. 15 represents an experimentally based derivation of the outbound force through kinematic expressions of the dynamic properties of the rotary propulsion engines while a craft is in steady state motion, and when appropriately modified, when the craft is accelerating or decelerating. One hypothetical way to derive said outbound force acting on the armature is through application of algorithms. These models successively evaluate the reaction mass' radial or outbound motion along the rotating rails, by computationally parsing the travel time, outwards from the axis of rotation (or any other start point), to the breech, into minuscule periods, and solving them sequentially. This data can then be used to determine not only the outbounding force of the reaction mass or armature but also to evaluate the resistive effect of the outbounding force on an inwardly driven reaction mass or armature in a rotating environment.

Under craft steady state motion, at instantaneous time period t=0, the rail is oriented vertically at ninety degrees and the reaction mass, situated at some distance ⁰r (r=0), from the axis of rotation, possesses a tangential velocity vector Vₜ(0) which is directed horizontally at 0°, or at a right angle to the rail. The magnitude of the reaction mass's said initial instantaneous tangential velocity vector, is given as:

Vₜ(0)=ω ⁰r

Where, ω is the known and constant angular velocity of the reaction mass.

After some known and constant minuscule time span time t=0−1, or Δt, the rotating rail has turned through known and constant minuscule angle Δφ° as expressed below:

Δφ°=ωΔt=Constant

Theorizing that during time span Δt, as the rail rotates through angle Δφ°, during time period t=0−1, tangential velocity vector, Vₜ(0), which will now be designated as Vₜ*(0), due to its innate linear inertia, will remain constant and unchanged, both in magnitude and orientation. Meaning, that its linear inertial trajectory is assumed not to orthogonally adjust in sync with the rotating rail. Consequently, its angular orientation continuously changes relative to the rotating rail. This results in an outbound radial velocity vector component, V(0−1)_{(ob)}(t) along the rail, which drives the reaction mass outwardly along the rail, and may be expressed as:

V(0−1)_{(ob)}(t)=[1−μₛᵤₘ]sin Vₜ*(0)

Where, μₛᵤₘ is the sum of the frictional coefficients.

The outbound acceleration a(0−1)_{(ob)}(t) of the reaction mass, as it goes from its outbound velocity of zero at time t=0, to its value at time t=1, may be given as:

$${a ( 0 - 1 )}_{( ob )} ( t ) = \frac{{V ( 0 - 1 )}_{( ob )} ( t )}{Δ t}$$

The outbound force F(0−1)_{(ob)}(t) of mass mₚ as a function of time for this segment may be given as:

F(0−1)_{(ob)}(t)=mₚ[a(0−1)_{ob)}(t)]

As soon as the data has been compiled for this segment, the algorithm refreshes itself, and repeats the process, until the breech is reached.

In the outbound phase, the armature, when confined to the first or fourth quadrants, heads in the general positive x-axis direction, which is in the same general direction as the flight path of the craft, and hence contributes to its motion, through frictional interaction with the craft, via the smooth rails. On the other hand, during the inbound phase, the armature travels in the opposite direction to the craft and as such, is frictionally resistive to the craft motion. As such, there is essentially no net effect to the craft's speed from the opposing inbound and outbound armature motions since they essentially cancel themselves out.

A similar analysis may be carried out by persons skilled in the art for the circumstance where craft is accelerating or decelerating. Under such conditions, the velocity, and therefore the distance covered as a function of time, by the armature relative to the craft, does diverge from what it would have been under craft steady state motion.

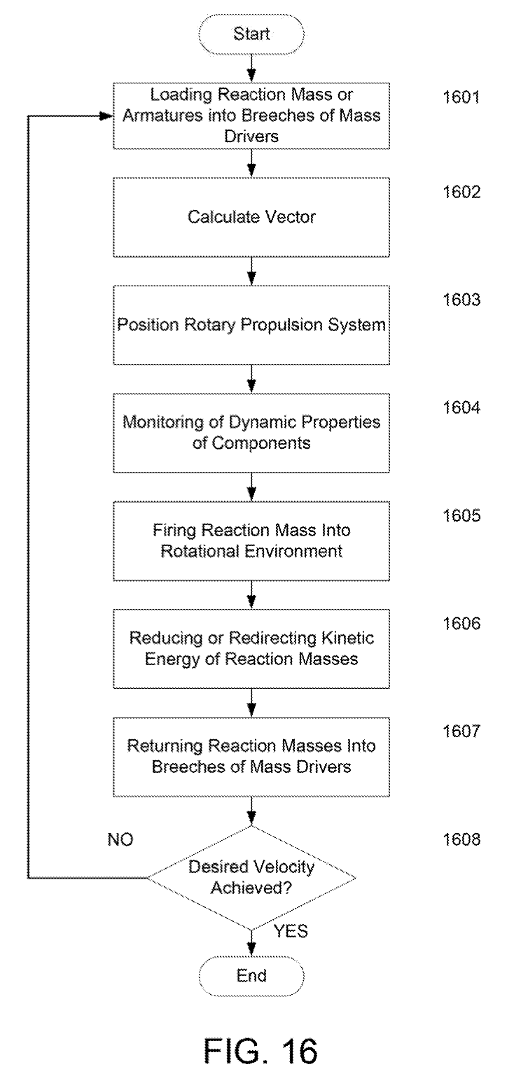

FIG. 16 illustrates a flow chart method for the operation of the exemplary rotary propulsion engine system as described in accordance with an embodiment of the present invention. Such a flow chart method is capable of being implemented through a guidance system means employing sensors and computer-based algorithms which will be readily understood and appreciated by persons having skill in the art. As has been described in the above specification, the method of operating a craft using the rotary propulsion engine system first involves the loading of reaction masses or armatures into the breeches of two of the mass drivers. The method may then involve calculating a desired vector 1602 for the craft. Once a vector is calculated, the rotary propulsion engine system may be positioned in such a manner so as to propel the craft in the desired direction 1603. Persons having skill in the art will readily appreciate that positioning the rotary propulsion system may be achieved through numerous means including, but not limited to, sensors monitoring components and electric motors or hydraulic actuators.

Throughout the course of operation, a guidance system means employing sensors and computer-based algorithms calculates the dynamic properties of each component of the exemplary rotary propulsion engine system 1604. The reaction masses are then fired in pairs into the rotational environments of the two counterrotating discs 1605. The firing of the reaction masses produces recoil which propels the vessel in a direction opposite the direction of the reaction masses, while the rotating environment reduces and/or redirects the kinetic energy of the two reaction masses 1606. The reaction masses are then returned to the breeches of their respective mass drivers 1607. The guidance system's sensors may then determine whether the desired velocity of the craft has been achieved 1608. If the desired velocity has not been achieved, then the method is repeated.

It will be understood by persons skilled in the art that each block of the block diagram and/or flowchart illustration, and combinations of blocks in the block diagrams and/or flowchart illustration, can be implemented by a guidance system means employing special purpose hardware and software-based guidance systems that perform the specified functions or acts, or combinations of special purpose hardware and computer instructions. Such instructions may be stored in a computer readable medium that can direct a computer, other programmable data processing apparatus, or other devices to function in a particular manner, such that the instructions stored in the computer readable medium produce a signal to implement the mechanical function/act specified in the flowchart and/or block diagram block or blocks.

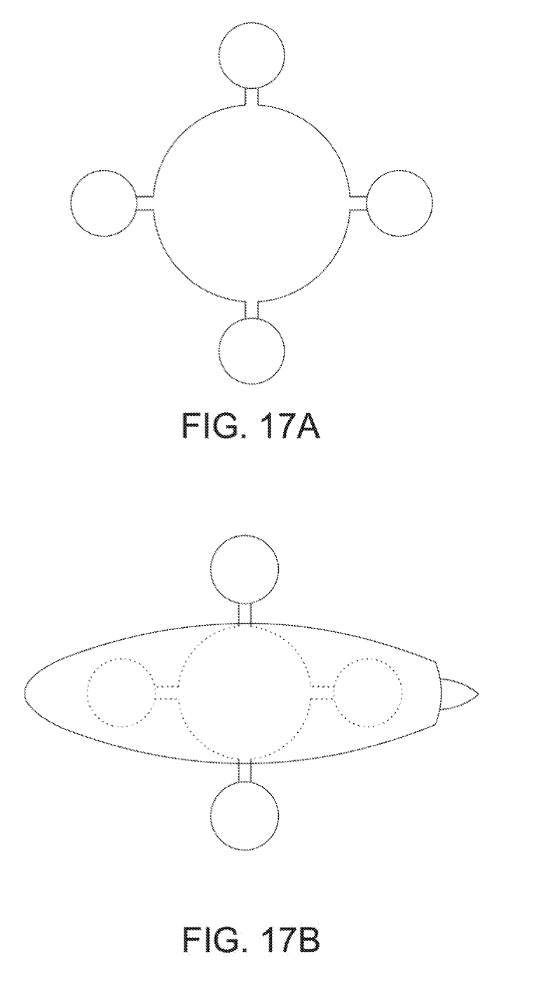

FIG. 17A and FIG. 17B represent, for illustrative purposes, two general top-view depictions of rotary propulsion engines configured to a spacecraft. These drawings are simplistic and hypothetical representations of a spacecraft configured with one or more rotary propulsion engine systems. When properly configured, such craft would be able to, similarly to a fixed wing or rotary aircraft, produce lift and thrust and execute pitch, yaw and roll maneuvers. In addition, similar to a helicopter, such a craft would be able to take off and land vertically, hover and move forward, backwards or laterally. FIG. 17A is a simple representation of a spherical craft equipped with four pairs of the rotary propulsion engines. FIG. 17B is a football shaped craft similarly equipped with four pairs of the rotary propulsion engines. In both illustrations, the spacecraft's rotary propulsion engines are configured around a central hub. The shape and size of a proposed craft is generally dictated by design and engineering considerations.

A craft utilizing rotary propulsion engines may employ a variety of power sources to provide electromagnetic power for said craft. Such power resources may include, but are not limited to, compact nuclear power generators, ambient electromagnetic radiation such as solar power, solar wind and galactic cosmic rays, beamed power such as lasers and masers. Nuclear propulsion represents an obvious type of long lasting potential power source for present embodiments of a spacecraft employing the rotary propulsion engines. However, nuclear power may present a hazard in case of catastrophic failure. Naturally, solar power is an optimal power source. In the future, power for such a craft may be provided by means such as miniaturized fusion power plants, and matter/antimatter reactors. In the far distant future, sources such as dark energy, exotic particles, exotic matter, interactions with the fabric of space time, and micro black holes may form the basis for super reactors and power generators.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the exemplary propulsion system, other equivalent or alternative methods of implementing the propulsion system according to the present invention will be apparent to those skilled in the art. Various aspects of the invention have been described above by way of illustration, and the specific embodiments disclosed are not intended to limit the invention to the particular forms disclosed. The particular implementation of the propulsion system may vary depending upon the particular context or application.

By way of example, and not limitation, the rotary propulsion engines described in the foregoing is principally directed towards a spacecraft. However, similar techniques may additionally be applied to land craft, watercraft or aircraft, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Although specific features of the invention are shown in some drawings and not others, persons skilled in the art will understand that this is for convenience. Each feature may be combined with any or all of the other features in accordance with the invention. The words “including,” “comprising,” “having,” and “with” as used herein are to be interpreted broadly and comprehensively and are not limited to any physical interconnection. Claim elements and steps herein may have been numbered and/or lettered solely as an aid in readability and understanding. Any such numbering and lettering in itself is not intended to and should not be taken to indicate the ordering of elements and/or steps in the claims to be added at a later date.

Any amendment presented during the prosecution of the application for this patent is not a disclaimer of any claim element presented in the description or claims to be filed. Persons skilled in the art cannot reasonably be expected to draft a claim that would literally encompass each and every equivalent.

What is claimed is:

1. A rotary propulsion engine system comprising:
a. a power supply;
b. at least two reaction masses or armatures;
c. at least two reaction mass driver assemblies;
d. at least two travel pathways for said reaction masses or armatures;
e. a counterrotating disc assembly including two counterrotating discs housing an equal number of the at least two said reaction mass drivers and travel pathways;
f a drive mechanism means to rotate the two said counterrotating discs;
g. an axle assembly;
h. a counterbalancing means used to maintain a balanced distribution of masses about the axis of rotation of each counterrotating disc in order to maintain a zero-horizontal torque sum as the armature moves along its ballistic trajectory; and
i. a guidance system means for calculating the dynamic properties of the reaction mass or armature, counterrotating disc assembly, and counterbalancing means.

2. The rotary propulsion engine system of claim 1 wherein the axle assembly of the two counterrotating discs housing said reaction mass drivers share a common axis of rotation;

3. The rotary propulsion engine system of claim 1 wherein the two counterrotating discs housing said reaction mass drivers are driven by electric motors.

4. The rotary propulsion engine system of claim 1 wherein the two counterrotating discs are axially connected by an axle assembly and protective cover.

5. The rotary propulsion engine system of claim 1 wherein the mass drivers are rail guns.

6. The rotary propulsion engine system of claim 1 wherein the mass drivers are coil guns.

7. The rotary propulsion engine system of claim 1 wherein the counterbalancing means consists of one pair of counterweights per travel pathway for said reaction masses or armatures positioned on the opposite ends of said travel pathways from the said reaction mass driver assemblies, said counterweights configured to pivot circumferentially in a manner so as to maintain a balanced distribution of masses about the axis of rotation in order to maintain a zero horizontal torque sum as the said reaction masses or armatures move along their ballistic trajectories.

8. The rotary propulsion engine system of claim 1 wherein said guidance system means calculates and governs the dynamic properties of the reaction mass or armature and rotational velocity of the counterrotating discs through computer-based algorithms.

9. The rotary propulsion engine system of claim 1 wherein the dynamic properties of the counterweights are calculated and governed through computer-based algorithms.

10. A rotary propulsion engine system comprising:
a. a power supply;
b. at least two reaction masses or armatures;
c. at least two reaction mass driver assemblies;
d. at least two travel pathways for said reaction masses or armatures;
e. a counterrotating disc assembly including two counterrotating discs housing an equal number of the at least two said reaction mass drivers and travel pathways;
f a drive mechanism means to rotate the two said counterrotating discs;
g. at least two reinforced breeches of said mass drivers used to recycle the kinetic energy of said reaction masses as a propulsive force;
h. an axle assembly;
i. a counterbalancing means used to maintain a balanced distribution of masses about the axis of rotation of each counterrotating disc in order to maintain a zero-horizontal torque sum as the armature moves along its ballistic trajectory; and
j. a guidance system means for calculating the dynamic properties of the reaction mass or armature, counterrotating disc assembly, and counterbalancing means.

11. The rotary propulsion engine system of claim 10 wherein wherein the axle assembly of the two counterrotating discs housing said reaction mass drivers share a common axis of rotation;

12. The rotary propulsion engine system of claim 10 wherein the two counterrotating discs housing said reaction mass drivers are driven by electric motors.

13. The rotary propulsion engine system of claim 10 wherein the two counterrotating discs are axially connected by an axle assembly and protective cover.

14. The rotary propulsion engine system of claim 10 wherein the mass drivers are rail guns.

15. The rotary propulsion engine system of claim 10 wherein the mass drivers are coil guns.

16. The rotary propulsion engine system of claim 10 wherein the travel pathways for said reaction masses or armatures traverse the diameters of the counterrotating discs.

17. The rotary propulsion engine system of claim 10 wherein the counterbalancing mechanism consists of one pair of counterweights per travel pathway for said reaction masses or armatures positioned on the opposite ends of said travel pathways from the said reaction mass driver assemblies, said counterweights configured to pivot circumferentially in a manner so as to maintain a balanced distribution of masses about the axis of rotation in order to maintain a zero horizontal torque sum as the said reaction masses or armatures move along their ballistic trajectories.

18. The rotary propulsion engine system of claim 10 wherein said guidance system calculates and governs the dynamic properties of the reaction mass or armature and rotational velocity of the counterrotating discs through computer-based algorithms.

19. The rotary propulsion engine system of claim 10 wherein the dynamic properties of the counterweights are calculated and governed through computer-based algorithms.

20. A method of propelling a craft using the rotary propulsion engine system of claim 1 or 9 comprising the steps of:
a. calculating a desired vector;
b. positioning the counterrotating discs in said recoil vector;
c. monitoring the dynamic properties of the components of said rotary propulsion engine system;
d. loading at least two reaction masses or armatures into the breeches of two mass drivers;
e. firing the two said mass drivers, using the recoil as a propulsive force;
f introducing each of the two said reaction masses into controlled, counterrotating rotational environments to reduce or redirect the kinetic energy of said reaction masses;
g. returning the two said reaction masses into the breeches of said mass drivers; and
h. repeating the method until desired velocity is achieved.
